(19) United States
(12) Patent Application Publication
(10) Pub. No.: US 2026/0164361 A1
(43) Pub. Date: Jun. 11, 2026

(54) WIRELESS COMMUNICATIONS POWER CONSERVATION

(71) Applicant: T-MOBILE INNOVATIONS LLC, Overland Park, KS (US)

(72) Inventors: Bhagwan Singh Khanka, Las Vegas, NV (US); Paul Henrich Antonio Gabriel, Las Vegas, NV (US)

(21) Appl. No.: 18/970,358

(22) Filed: Dec. 5, 2024

(51) Int. Cl. H04W 52/02; H04W 52/22; H04W 52/26

(52) U.S. Cl. CPC H04W 52/028; H04W 52/223; H04W 52/26

(57) ABSTRACT

A data system powers a radio capability to support a wireless data service. The data system estimates future quality for the wireless data service if the radio capability is depowered. The data system depowers the radio capability based on the estimate of the future quality. For example, future data throughput and latency estimates may exceed future quality thresholds, so the radio capability is depowered. The data system then determines actual quality for the wireless data service when the radio capability is depowered. The data system repowers the radio capability to support the wireless data service based on the determination of the actual quality. For example, actual data throughput and latency may both fall below actual quality thresholds due to increased loading, so the radio capability is repowered.

### TECHNICAL BACKGROUND

Wireless communication networks provide wireless data services to wireless communication devices like phones, computers, and other user devices. The wireless data services may include internet-access, user messaging, voice/video calling, or some other data communication product. The wireless communication networks comprise network elements that deliver the wireless data services. The network elements authenticate and select wireless data services for the wireless communication devices. The network elements then exchange user data to provide the selected wireless data services. Exemplary network elements include wireless access nodes, Access and Mobility Management Functions (AMFs), and User Plane Functions (UPFs).

The wireless access nodes comprise Fifth Generation New Radio (5GNR) cells, earth satellites, Wireless Fidelity (WIFI) hotspots, and other types of access technologies. The wireless access nodes feature radio capabilities like frequency channels, Multiple Input Multiple Output (MIMO) layers, radio units, and the like. A frequency channel is typically a block of wireless spectrum. The radio units transmit and receive data over various different frequency channels. The radio units use antenna characteristics to transmit data via the MIMO layers. The MIMO layers share time and frequency and are differentiated by their different antenna characteristics. These type of radio capabilities consume significant power. For example, the power amplifier in a radio unit requires a large amount of power to amplify wireless signals for transmission across a network sector. Wireless access nodes usually operate multiple power amplifiers.

The wireless communication devices have various radio features. Many wireless communication devices can use multiple access networks like 5GNR, WIFI, and satellite. Different wireless communication devices often use different combinations of wireless data services. A vehicle may use a vehicle-control service and an internet-access service while a smartphone uses the internet-access service and a video-calling service. The different services have different Qualities-of-Service (QoS). For example, the vehicle-control service may have a different data rate and latency than the internet-access service.

### TECHNICAL OVERVIEW

An exemplary data system comprises a data communication system and a communication control system. The data communication system powers a radio capability to support a wireless data service. The communication control system estimates future quality for the wireless data service if the radio capability is depowered. Based on the estimate, the communication control system transfers a depower instruction for the radio capability to the data communication system. The data communication system depowers the radio capability in response to the depower instruction. The communication control system determines actual quality for the wireless data service when the radio capability is depowered. Based on the determination, the communication control system transfers a repower instruction for the radio capability to the data communication system. The data communication system repowers the radio capability to support the wireless data service in response to the repower instruction.

In some examples, a method comprises the following operations. Power a radio capability to support wireless data service. Estimate future quality for the wireless data service if the radio capability is depowered. Depower the radio capability based on the estimate of the future quality. Determine actual quality for the wireless data service when the radio capability is depowered. Repower the radio capability to support the wireless data service based on the determination of the actual quality.

In some examples, a method comprises the following operations. A terrestrial access node uses a radio capability to deliver a wireless data service. A network control system determines initial usage of the wireless data service when delivered by the terrestrial access node. Based on the initial usage, the network control system transfers a depower signal for the radio capability to the terrestrial access node. The terrestrial access node depowers the radio capability in response to the depower signal. One or more satellite access nodes deliver the wireless data service when the radio capability is depowered. The network control system determines subsequent usage of the wireless data service when delivered by the satellite access nodes. Based on the subsequent usage, the network control system transfers a repower signal for the radio capability to the terrestrial access node. The terrestrial access node repowers the radio capability in response to the repower signal and uses the radio capability to deliver the wireless data service.

### DESCRIPTION OF THE DRAWINGS

FIG. 1 illustrates an exemplary data system to control power to a radio capability based on service quality.

FIG. 2 is a first diagram that illustrates an exemplary operation of the data system to control the power to the radio capability based on the service quality.

FIG. 3 is a second diagram that illustrates an exemplary operation of the data system to control the power to the radio capability based on the service quality.

FIG. 4 illustrates an exemplary wireless Access Node (AN) to control power to a radio capability based on service quality.

FIG. 5 illustrates an exemplary wireless communication network to control radio capabilities in terrestrial Fifth Generation New Radio (5GNR) ANs based on usage of satellite ANs.

FIG. 6 illustrates an exemplary User Equipment (UE) in the wireless communication network that controls the radio capabilities in the terrestrial 5GNR ANs based on the usage of the satellite ANs.

FIG. 7 illustrates an exemplary terrestrial 5GNR AN in the wireless communication network that controls the radio capabilities in the terrestrial 5GNR ANs based on the usage of the satellite ANs.

FIG. 8 illustrates an exemplary Wireless Fidelity (WIFI) AN in the wireless communication network that controls the radio capability in the terrestrial 5GNR access node based on the usage of the satellite ANs.

FIG. 9 illustrates an exemplary Satellite (SAT) AN and SAT Ground Station (GND) in the wireless communication network that controls the radio capabilities in the terrestrial 5GNR ANs based on the usage of the satellite ANs.

FIG. 10 illustrates an exemplary Network Function Virtualization Infrastructure (NFVI) in the wireless communication network that controls the radio capabilities in the terrestrial 5GNR ANs based on the usage of the satellite ANs.

FIGS. 11-12 illustrate an exemplary operation of the wireless communication network to control the radio capabilities in the terrestrial 5GNR ANs based on the usage of the satellite ANs.

FIG. 13 illustrates exemplary processing circuitry to control power to a radio capability based on service quality.

### DETAILED DESCRIPTION

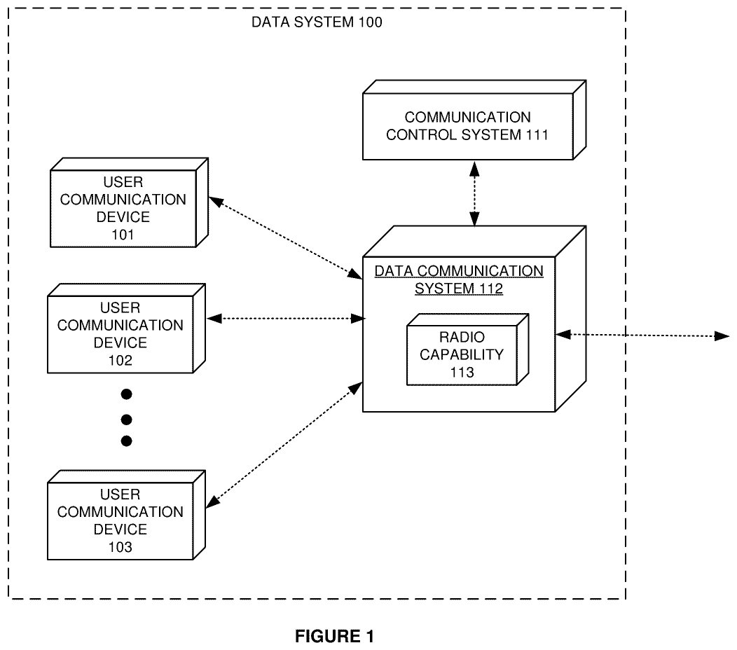

FIG. 1 illustrates exemplary data system 100 to control power to radio capability 113 based on service quality. Data system 100 comprises user communication devices 101-103, communication control system 111, and data communication system 112. Data communication system 112 comprises radio capability 113. User communication devices 101-103 comprise phones, computers, vehicles, and/or some other user apparatus with wireless communication components. Communication control system 111 comprises an Access and Mobility Management Function (AMF), Session Management Function (SMF), access node controller, and/or some other control-plane network elements. Data communication system 112 comprises wireless access nodes, satellite ground stations, User Plane Functions (UPFs), and/or some other user-plane network elements. Radio capability 113 comprises a frequency channel, Multiple Input Multiple Output (MIMO) layer, radio transceiver, baseband unit, network slice, and/or some other wireless communication component.

In some examples, data communication system 112 delivers one or more wireless data services to user communication devices 101-103. Data communication system 112 powers radio capability 113 to support the wireless data services for user communication devices 101-103. Communication control system 111 estimates future quality for the wireless data services if radio capability 113 is depowered. The estimate of the future quality could be an estimate of future data throughput, latency, error rate, and the like. Communication control system 111 will direct data communication system 112 to depower radio capability 113 when the future quality estimate meets or exceeds a future quality threshold. Based on a positive estimate, communication control system 111 transfers a depower instruction for radio capability 113 to data communication system 112. Data communication system 112 depowers radio capability 113 in response to the depower instruction. Communication control system 111 now determines actual quality for the wireless data services when radio capability 113 is depowered. The determination of the actual quality could be a determination of actual data throughput, latency, error rate, and the like. Communication control system 111 will direct data communication system 112 to depower radio capability 113 when the actual quality falls to or falls below an actual quality threshold. Based on a negative determination, communication control system 111 transfers a repower instruction for radio capability 113 to data communication system 112. Data communication system 112 repowers radio capability 113 to support the wireless data services in response to the repower instruction.

Communication control system 111 may estimate the future quality and determine the actual quality based on radio configurations of user communication devices 101-103, data flow types for the wireless data services, radio configurations of wireless access nodes, and/or wireless usage of the wireless access nodes. The radio configurations of user communication devices 101-103 can be used to determine device options when radio capability 113 is depowered—like using a different frequency channel or a different radio. These radio configurations indicate device features like Fifth Generation New Radio (5GNR), Long Term Evolution (LTE), 5GNR Stand Alone (SA), 5GNR Non Stand Alone (NSA), Voice over 5GNR (VoNR), Voice over LTE (VoLTE), Global System for Mobile Communications (GSM), 4×4 MIMO, 4×2 MIMO, beamforming, maximum data throughput, radio types, and available frequency channels. The radio configurations of data communication system 112 can also be used to determine device options when radio capability 113 is depowered—like using a different frequency channel or using satellite-based communications. These radio configurations indicate node features like baseband version, baseband capacity, baseband power consumption, radio types, radio layers, and radio power consumption. For the various device options, the data flow types are used to estimate the future service qualities and to select the device option that has the most power savings while providing adequate service qualities to the various data flows. The actual service qualities for the different data flow types are used to continue the power savings until the actual quality for one of the data flows requires additional power.

Before depowering radio capability 113, communication control system 111 may direct data communication system 112 to move user communication devices 101-103 to a different frequency channel, Multiple Input Multiple Output (MIMO) layer, radio, wireless network slice, and/or some other system component. To offload radio capability 113, data communication system 112 then moves user communication devices 101-103 to the different frequency channel, MIMO layer, radio, wireless network slice and/or other system component. Communication control system 111 may direct data communication system 112 to move user communication devices 101-103 back after repowering radio capability 113.

In some examples, data communication system 112 comprises a terrestrial access node and satellite access nodes. The terrestrial access node uses radio capability 113 to deliver one or more of the wireless data services. Communication control system 111 determines initial usage of the wireless data services when delivered by the terrestrial access node. Communication control system 111 determines the status of the satellite access nodes. Based on the initial usage and the satellite status, communication control system 111 transfers a depower signal for radio capability 113 to the terrestrial access node, because the initial usage can be adequately served by the satellite access nodes without radio capability 113. The terrestrial access node depowers radio capability 113 in response to the depower signal. The satellite access nodes deliver the wireless data services to user communication devices 101-103 when radio capability 113 is depowered. Communication control system 111 determines actual usage of the wireless data services when delivered by the satellite access nodes. Communication control system 111 directs user communication devices 101-103 to use the terrestrial access node, because the actual usage indicates that radio capability 113 will be needed to maintain adequate service quality. Communication control system 111 transfers a repower signal for radio capability 113 to the terrestrial access node. The terrestrial access node repowers radio capability 113 in response to the repower signal. The terrestrial access node uses radio capability 113 to deliver the wireless data services to user communication devices 101-103. For example, user communication devices 101-103 may use radio capability 113 to access the internet, but use the satellite access nodes to access the internet when radio capability 113 is depowered.

In some examples, user communication devices 101-103 and data communication system 112 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), satellite data communications and/or some other wireless protocol. User communication devices 101-103, communication control system 111, data communication system 112 (including radio capability 113) comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

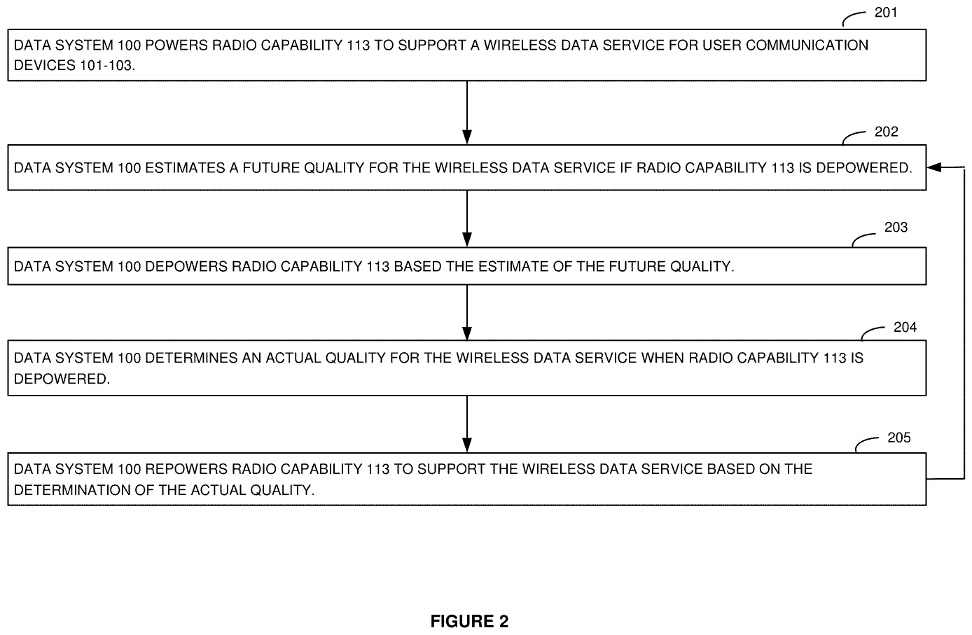

FIG. 2 illustrates an exemplary operation of data system 100 to control the power to radio capability 113 based on the service quality. The operation may differ in other examples. Data system 100 powers radio capability 113 to support a wireless data service for user communication devices 101-103 (201). Data system 100 estimates future quality for the wireless data service if radio capability 113 is depowered (202). The estimate of the future quality could be an estimate of future data throughput, latency, error rate, and the like. For example, data system 200 may host a data structure that translates the current load, throughput, and latency into a future quality estimate based on historical data for the day and time. Based on the future estimate, data system 100 depowers radio capability 113 (203). Data system 100 determines actual quality for the wireless data service when radio capability 113 is depowered (204). The determination of the actual quality could be a determination of actual data throughput, latency, error rate, and the like. Based on the actual determination, data system 100 repowers radio capability 113 to support the wireless data service (205). The operation may now repeat (202-205).

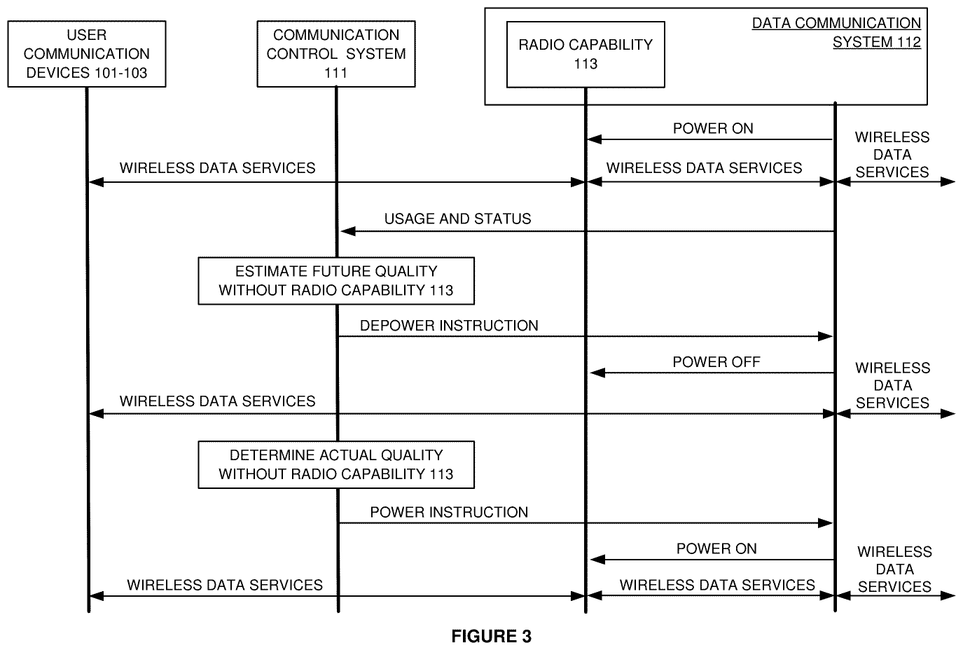

FIG. 3 illustrates an exemplary operation of data system 100 to control the power to radio capability 113 based on the service quality. The operation may differ in other examples. Data communication system 112 powers radio capability 113. For example, data communication system 112 may close a power transistor that supplies radio capability 113. Data communication system 112 delivers wireless data services to user communication devices 101-103 using radio capability 113. For example, radio capability 113 may comprise MIMO layers, and user communication devices 101-103 and data communication system 112 may use the MIMO layers to exchange user data in parallel for the wireless data services. Data communication system 112 transfers data usage and network status for the wireless data services to communication control system 111. Based on the usage and status, communication control system 111 estimates future quality for the wireless data services if radio capability 113 is depowered. The estimate of the future quality could be an estimate of future data throughput, latency, error rate, and the like. For example, the estimate of future quality may comprise the estimated throughput and latency when the MIMO layers in radio capability 113 are depowered. Historical quality data for the current usage level and future node configuration could be used to estimate the future quality. For example, the future quality estimate may comprise a historical quality level for the current service load when MIMO layers were not used. Based on a future estimate of acceptable quality without radio capability 113, communication control system 111 transfers a depower instruction for radio capability 113 to data communication system 112. Data communication system 112 depowers radio capability 113 in response to the depower instruction. For example, data communication system 112 may open the power transistor that supplies radio capability 113.

To save power consumption, data communication system 112 now delivers the wireless data services to user communication devices 101-103 without using radio capability 113. For example, a wireless access node in data communication system 112 may no longer use MIMO layers to support the wireless data services for user communication devices 101-103. Data communication system 112 transfers data usage and network status for the wireless data services to communication control system 111. Based on the usage and status, communication control system 111 determines actual quality for the wireless data services when radio capability 113 is depowered. The determination of the actual quality could be the actual data throughput, latency, error rate, and the like when the MIMO layers are depowered. Historical data may be used to project increasing loads and degrading service quality. When the actual determination indicates unacceptable quality, communication control system 111 transfers a repower instruction for radio capability 113 to data communication system 112. Data communication system 112 repowers radio capability 113 in response to the repower instruction. For example, data communication system 112 may again close the power transistor that supplies radio capability 113. Data communication system 112 now delivers the wireless data services to user communication devices 101-103 by using radio capability 113.

Advantageously, data system 100 conserves the power consumed by radio capability 113. Moreover, data system 100 maintains adequate service quality for user communication devices 101-103.

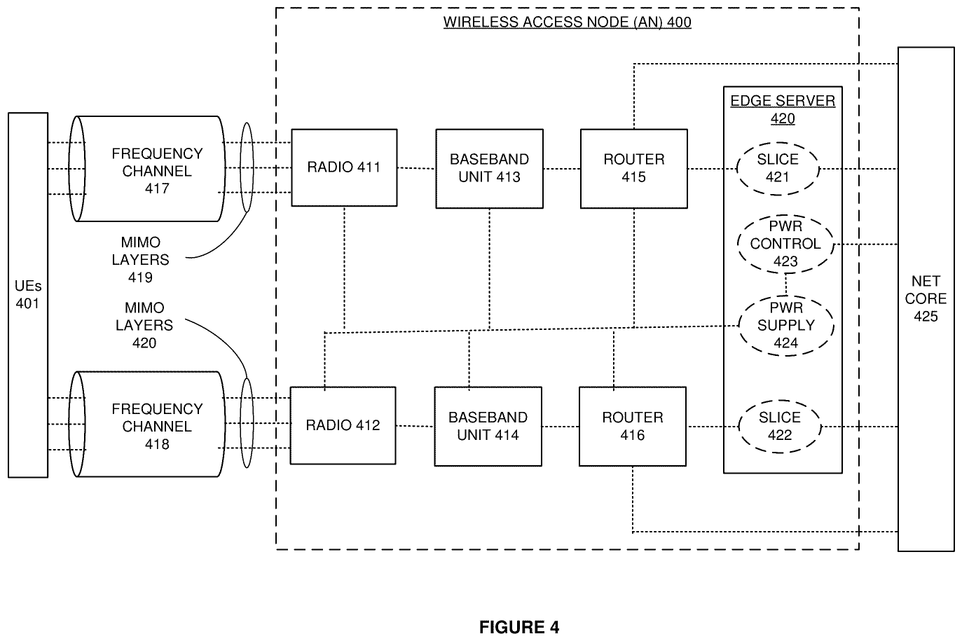

FIG. 4 illustrates exemplary wireless Access Node (AN) 400 to control power to a radio capability based on service quality. Wireless AN 400 comprises an example of communication control system 111 and data communication system 112, although systems 111-112 may differ. Wireless AN 400 comprises radios 411-412, baseband units 413-414, routers 415-416, and edge server 420. Edge server 420 comprises wireless network slices 421-422, power (PWR) control 423, and power supply 424. UEs 401 and radio 411 wirelessly communicate over frequency channel 417 using MIMO layers 419. Radio 411 and network core 425 communicate over baseband unit 413, router 415, and possibly wireless network slice 421. UEs 401 and radio 412 wirelessly communicate over frequency channel 418 using MIMO layers 420. Radio 412 and network core 425 communicate over baseband unit 414, router 416, and possibly wireless network slice 422.

UEs 401 and network core 425 exchange signaling and user data over wireless access node 400. UEs 401 and network core 425 communicate over frequency channels 417-418, MIMO layers 419-420, radios 411-412, baseband units 413-414, routers 415-416, and wireless network slices 421-422. Network core 425 determines radio configurations and service requirements for UEs 401 based on the signaling and subscriber information. Network core 425 transfers the radio configurations and service requirements to power control 423. Power control 423 determines node configurations, data usage, data rate, data latency, error rate, and other node status data based on information from radios 411-412, baseband units 413-414, routers 415-416, and slices 421-422. Power control 423 determines possible radio configurations for wireless access node 400 based on the radio configuration data and/or a pre-configured list of radio configurations. Power control 425 estimates the future service qualities for the individual future node configurations. The future quality estimates project the current service load onto the future node configuration.

Power control 423 selects the future node configuration that reduces power consumption the most while maintaining service quality at or above a quality threshold. For example, various node configurations could depower one or more of frequency channel 417, MIMO layers 419, radio 411, baseband unit 413, router 415, or slice 421. The selected node configuration may include the transfer of UEs 401 from frequency channel 417, MIMO layers 419, and radio 411 to frequency channel 418, MIMO layers 420, and radio 412.

In this example, power control 423 directs power supply 424 to depower frequency channel 417, MIMO layers 419, radio 411, baseband unit 413, router 415, and slice 421. In other examples, various portions or combinations of these elements could be depowered. In response, power supply 424 removes power from frequency channel 417, MIMO layers 419, radio 411, baseband unit 413, router 415, and slice 421. To save power consumption, UEs 401 and network core 425 now communicate over frequency channel 418, MIMO layers 420, radio 412, baseband unit 414, router 416, and wireless network slice 422.

Subsequently, power control 423 determines the actual service quality for UEs 401 like the actual data usage, data rate, data latency, error rate, and other network status. Power control 423 compares the actual service quality to a quality threshold and repowers the above-depowered elements when the actual service quality falls to or falls below this quality threshold. Due to an increasing load and resulting quality degradation, power control 423 determines that frequency channel 417, MIMO layers 419, radio 411, baseband unit 413, router 415, and slice 421 should be repowered to maintain service quality at or above the quality threshold. Other factors like historical usage may be used as well.

Power control 423 directs power supply 424 to repower frequency channel 417, MIMO layers 419, radio 411, baseband unit 413, router 415, and slice 421. In response, power supply 424 supplies power to frequency channel 417, MIMO layers 419, radio 411, baseband unit 413, router 415, and slice 421. UEs 401 and network core 425 again communicate over frequency channels 417-418, MIMO layers 419-420, radios 411-412, baseband units 413-414, routers 415-416, and wireless network slices 421-422.

The above operations may now repeat to implement various power-saving scenarios while maintaining acceptable service quality. In some alternative examples, power control 423 resides in network core 425 instead of wireless AN 400—or power control 423 could be distributed between network core 425 and wireless AN 400. In other alternative examples, power control 423 could depower and repower radio capabilities without requiring information from network core 425.

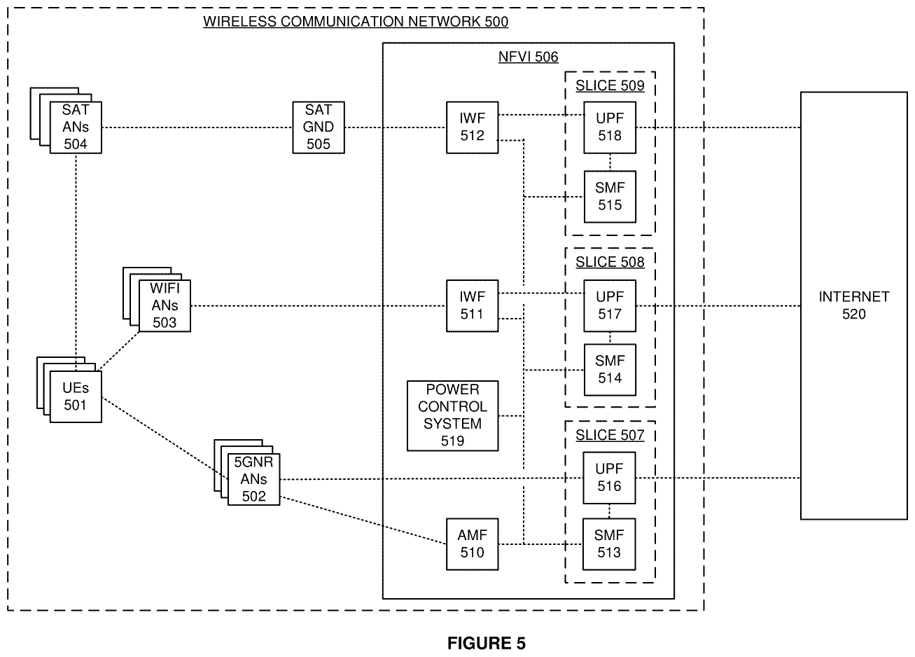

FIG. 5 illustrates exemplary wireless communication network 500 to control a radio capability in terrestrial Fifth Generation New Radio (5GNR) AN 502 based on usage of satellite ANs 504. Wireless communication network 500 comprises an example of data system 100, although system 100 may differ. Wireless communication network 500 comprises User Equipment (UEs) 501, Fifth Generation New Radio (5GNR) ANs 502, Wireless Fidelity (WIFI) ANs 503, earth satellite (SAT) ANs 504, satellite ground station (SAT GND) 505, and Network Function Virtualization Infrastructure (NFVI) 506. NFVI 506 comprises wireless network slices 507-509, Access and Mobility Management Function (AMF) 510, Interworking Functions (IWFs) 511-512, and power control system 519. Wireless network slice 507 comprises Session Management Function (SMF) 513 and User Plane Function (UPF) 516. Wireless network slice 508 comprises SMF 514 and UPF 517. Wireless network slice 509 comprises SMF 515 and UPF 518.

Power control system 519 stores radio configuration information for ANs 502-504. The radio configuration information for ANs 502-504 indicates frequency channels, MIMO layers, slice/service support, RUs, DUs, CUs, and SAT GNDs along with historical performance data like throughput and latency. Power control system 519 also receives radio configuration information for UEs 501 like their access technologies, antenna configurations, radios, slices/services, throughputs, latencies, and the like.

To access Internet 520, UEs 501 may use: 1) 5GNR ANs 502 and slice 507, 2) WIFI ANs 503, IWF 511, and slice 508, and/or 3) SAT ANs 504, SAT GND 505, IWF 512, and slice 509. ANs 502-504 and UPFs 515-518 transfer usage and status data to respective SMFs 513-515. SMFs 513-515 transfer the usage and status data to power control system 519. The usage and status data indicates data loads and the like for individual MIMO layers, frequency channels, radio units, distributed units, centralized units, UPFs, slices/services, and the like. Power control system 519 processes the configuration, usage, and status data to identify radio capabilities that can be depowered while maintaining acceptable service quality. For example, power control system 519 may comprise a data structure that indicates the components, requirements, and power consumption for different network configurations. Power control system 519 could then verify the availability of individual network configurations based on the configuration and status data, and then select the lowest power one of the configurations that can handle the usage.

In this example, power control system 519 directs 5GNR ANs 502 to depower and repower radio units, while SAT ANs 504 help maintain acceptable access to Internet 520 for UEs 501. For example, power control system 519 could estimate internet-access throughput when different combinations of radio units are shut-off and select the combination that has the most power savings and sufficient internet-access throughput. In this example, power control system 519 verifies that the current load over these radio units in 5GNR ANs 502 will be adequately handled by SAT ANs 504, SAT GND 505, IWF 512, and slice 509. Over SMF 513 and AMF 510, power control system 519 directs UEs 501 that are attached to the selected radio units to use SAT ANs 503 to access Internet 520. Over SMF 513 and AMF 510, power control system 519 directs 5GNR ANs 502 to depower the selected radio units. UEs 501 that were attached to the selected radio units now use SAT ANs 504 to access Internet 520.

SAT ANs 503 and UPF 518 continue to transfer usage and status data to respective SMF 515. SMF 515 transfers the usage and status data to power control system 519. Power control system 519 processes the configuration, usage, and status data to identify radio capabilities that should be repowered to maintain acceptable service quality. In particular, power control system 519 determines that due to increasing loading, SAT ANs 504 will no longer provide UEs 501 with suitable access to internet 520. In response, power control system 519 determines that the depowered radio units in 5GNR ANs 502 should be repowered to maintain service quality. Over SMF 513 and AMF 510, power control system 519 directs 5GNR ANs 502 to repower the selected radio units. Over SMF 513 and AMF 510, power control system 519 directs UEs 501 to reattach to the repowered radio units and use 5GNR ANs 502 to access internet 520. UEs 501 that were attached SAT ANs 504 now use the repowered radio units in 5GNR ANs 502 to access internet 520.

When the selected radio units are depowered, some UEs 501 may use other radio units in 5GNR ANs 502 instead of using SAT ANs 504. When the selected radio units are repowered, some UEs 501 may remain on SAT ANs 504 instead of using 5GNR ANs 502. In alternative examples, power control system 519 could be distributed among 5GNR ANs 502, SAT ANs 504, and NFVI 506. In other examples, 5GNR ANs 502 could implement the power control and savings based on available information without the need for instructions from power control system 519. In addition, WIFI ANs 503, IWF 511, and slice 508 could be used to provide internet-access to UEs 501 in the manner of SAT ANs 504, SAT GND 505, IWF 512, and slice 509.

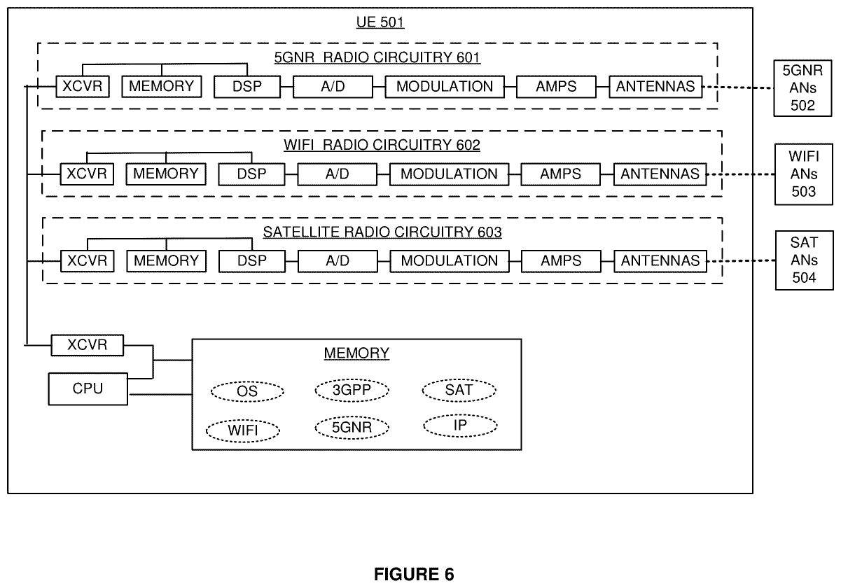

FIG. 6 illustrates an exemplary one of User Equipment (UEs) 501 in wireless communication network 500 that controls radio capabilities in terrestrial 5GNR ANs 502 based on the usage of the satellite ANs 504. The term “UE 501” is used herein to refer to one of UEs 501, and the other ones of UEs 501 would be configured and operate in a like manner. UE 501 comprises an example of user communication devices 101-103, although devices 101-103 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), and Internet Protocol Application (IP). The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. In particular, UE 501 indicates its capabilities like frequencies, layers, slices, and the like to wireless communication network 500.

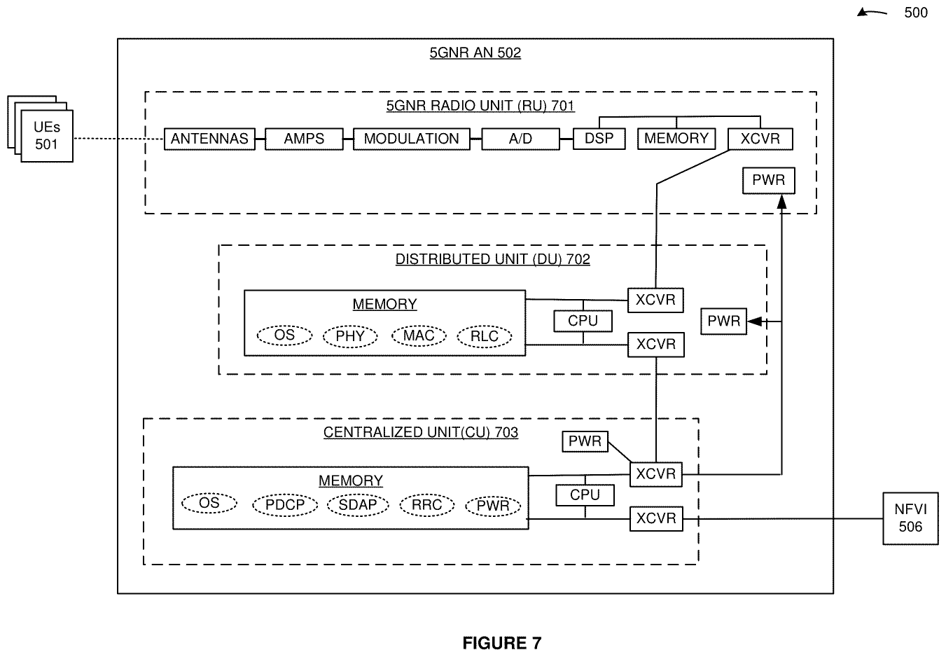

FIG. 7 illustrates exemplary one of terrestrial 5GNR ANs 502 in wireless communication network 500 that controls the radio capabilities in terrestrial 5GNR ANs 502 based on the usage of the satellite ANs 504. The term “5GNR AN 502” is used herein to refer to one of 5GNR ANs 502, and the other ones of 5GNR ANs 502 would be configured and operate in a like manner. 5GNR AN 502 comprises an example of communication control system 111, data communication system 112, and wireless AN 400, although systems 111-112 and AN 400 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, transceivers, and power supply (PWR) that are coupled over bus circuitry. DU 702 comprises memory, CPU, transceivers, and power supply that are coupled over bus circuitry. The memory in DU 702 stores operating system and 5GNR network applications for Physical Layer (PHY), Media Access Control (MAC), and Radio Link Control (RLC). CU 703 comprises memory, CPU, transceivers, and power supply that are coupled over bus circuitry. The memory in CU 703 stores an operating system and 5GNR network applications for Packet Data Convergence Protocol (PDCP), Service Data Adaption Protocol (SDAP), Radio Resource Control (RRC), and power control (PWR). The antennas in 5GNR RU 701 are wirelessly coupled to UEs 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein.

In some examples, 5GNR AN 502 serves UEs 501 when radio capabilities in WIFI AN 503 or SAT AN 504 are depowered. In other examples, power control system 519 in NFVI 506 instructs the power control application in CU 703 to power down radio capabilities to conserve power. In this example, RU 701 is powered down to save power. In response, the power control application in CU 703 signals the power supply in RU 701 to power-down. The power supply powers down RU 701. Subsequently, power control system 519 in NFVI 506 instructs the power control application in CU 703 to power up the radio capabilities to maintain service quality. In response, the power control application in CU 703 signals the power supply in RU 701 to power-up. The power supply would power up RU 701.

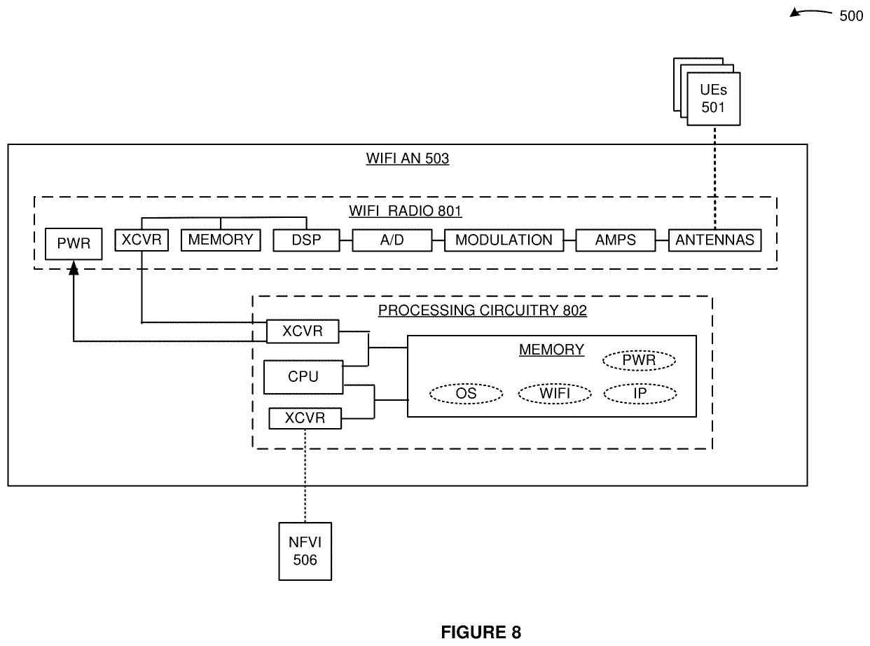

FIG. 8 illustrates exemplary Wireless Fidelity (WIFI) ANs 503 in wireless communication network 500 that control the radio capabilities in terrestrial 5GNR ANs 502 based on the usage of the satellite ANs 504. The term “WIFI AN 503” is used herein to refer to one of WIFI ANs 503, and the other ones of WIFI ANs 503 would be configured and operate in a like manner. WIFI AN 503 comprises an example of communication control system 111, data communication system 112, and wireless AN 400, although systems 111-112 and AN 400 may differ. WIFI AN 503 comprises WIFI radio 801 and processing circuitry 802. Radio 801 comprises antennas, amplifiers, filters, modulation, analog-to-digital interfaces, DSPs, memories, transceivers, and power supply that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein.

In some examples, WIFI AN 503 serves UEs 501 when RU 701 or some other radio capability is depowered in the manner of SAT AN 504. In other examples, power control system 519 in NFVI 506 instructs WIFI AN 504 to power down radio capabilities to conserve power. In response, the power control application in WIFI AN 503 signals the power supply in WIFI radio 801 to power-down. The power supply would power down radio 801. Subsequently, power control system 519 in NFVI 506 instructs WIFI AN 504 to power up the radio capabilities to maintain service quality. In response, the power control application in WIFI AN 503 signals the power supply in WIFI radio 801 to power-up. The power supply would power up radio 801.

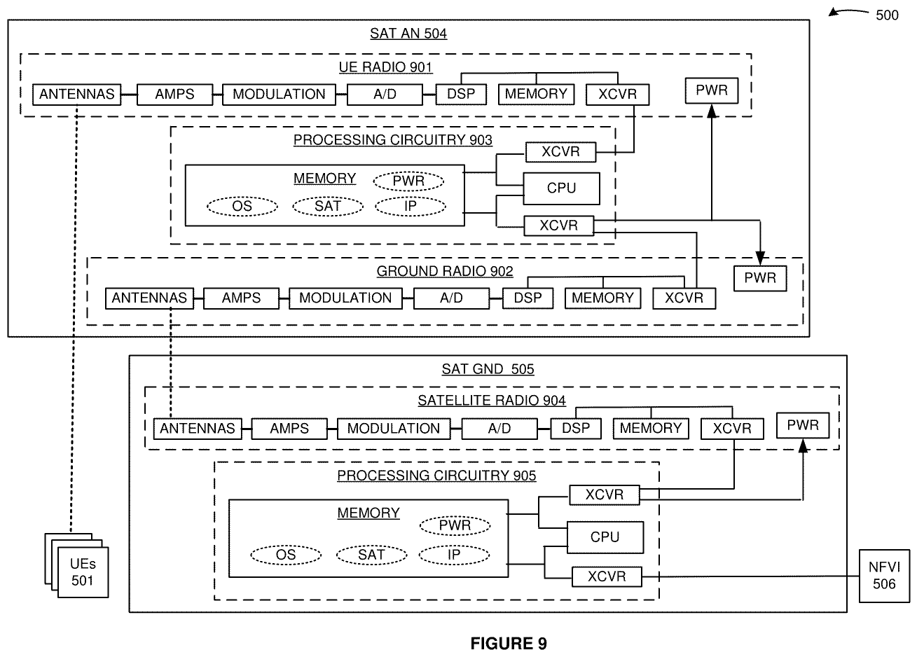

FIG. 9 illustrates an exemplary one of SAT ANs 504 and SAT GND 505 in wireless communication network 500 that controls the radio capabilities in terrestrial 5GNR ANs 502 based on the usage of the SAT ANs 504. The term “SAT AN 504” is used herein to refer to one of SAT ANs 504, and the other ones of SAT ANs 504 would be configured and operate in a like manner. SAT AN 504 and SAT GND 505 comprise an example of communication control system 111, data communication system 112, and wireless AN 400, although systems 111-112 and AN 400 may differ. SAT AN 504 comprises UE radio 901, ground radio 902 and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, transceivers, and power supplies that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), IP Application (IP), and power control application (PWR). The antennas in UE radio 901 exchange satellite signals with UEs 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UEs 501 and NFVI 506 as described herein.

In some examples, SAT AN 504 and SAT GND 505 serve UEs 501 when RU 701 or some other radio capability is depowered. In other examples, power control system 519 in NFVI 506 instructs SAT AN 504 and/or SAT GND 505 to power down radio capabilities to conserve power. In response, the power control application in SAT AN 504 may signal the power supplies in SAT radios 901 and/or 902 to power-down. The power supplies would power down radios 901 and/or 902. In response, the power control application in SAT GND 505 may signal the power supply in SAT radio 904 to power-down. The power supply would power down radio 904. Subsequently, power control system 519 in NFVI 506 may instruct SAT AN 504 and/or SAT GND 505 to power up the radio capabilities to maintain service quality. In response, the power control application in SAT AN 504 may signal the power supplies in SAT radios 901 and/or 902 to power-up. The power supplies would power up radios 901 and/or 902. In response, the power control application in SAT GND 505 may signal the power supply in SAT radio 904 to power-up. The power supply would power up radio 904.

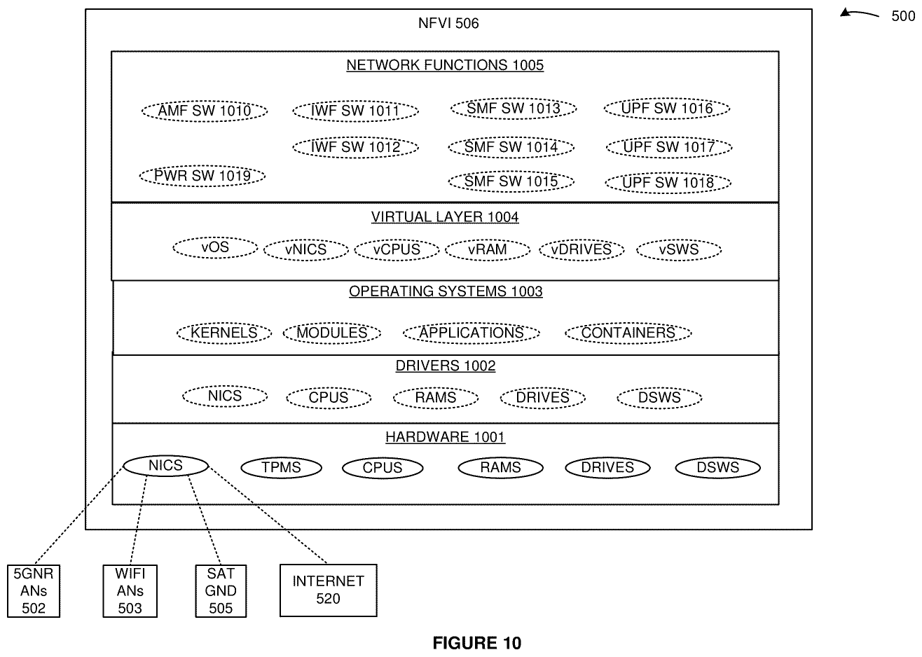

FIG. 10 illustrates exemplary Network Function Virtualization Infrastructure (NFVI) 506 in wireless communication network 500 that controls the radio capabilities in terrestrial 5GNR ANs 502 based on the usage of satellite ANs 504. NFVI 506 comprises an example of communication control system 111 and data communication system 112, although systems 111-112 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF SW 1010, IWF SW 1011-1012, SMF SW 1013-1015, UPF SW 1016-1018, and power control system (PWR) SW 1019. The NICS in hardware 1001 are coupled to ANs 502-503, SAT GND 505, and external systems. Hardware 1001 executes hardware drivers 1002, operating systems 1003, virtual layer 1004, and network functions 1005 to form and operate AMF 510, IWFs 511-512, SMFs 513-515, UPFs 516-518, and power control system 519 as described herein. NFVI 506 may be located at a single site or be distributed across multiple geographic areas.

In some examples, power control software 1019 determines loading and status information for ANs 502-504 and selects radio capabilities to depower and repower. For example, power control software 1019 may instruct 5GNR AN 502 to depower RU 701 when SAT ANs 504 can handle the load from RU 701. Power control software 1019 may instruct 5GNR AN 502 to repower RU 701 when SAT ANs 504 can no longer handle the load from RU 701.

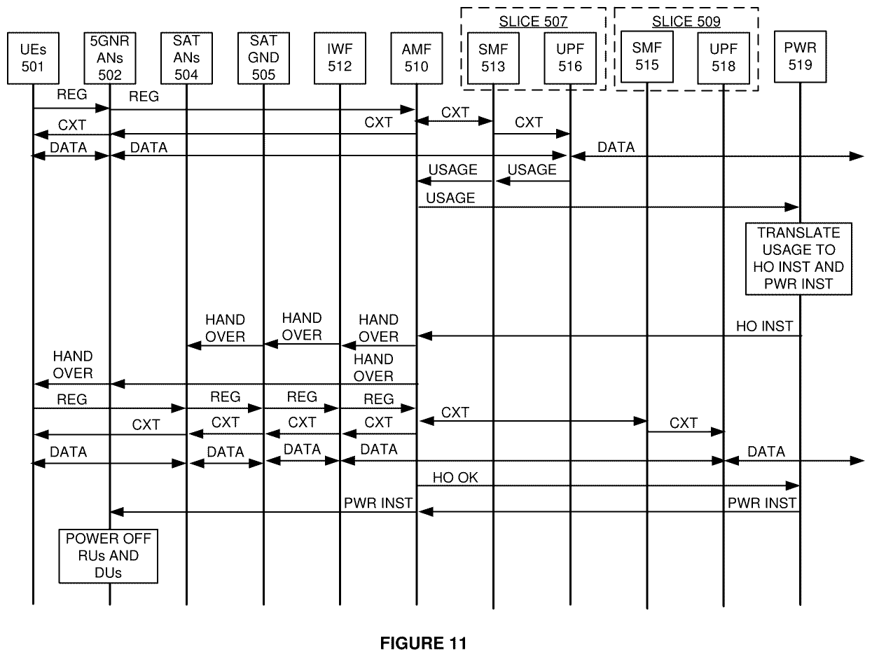

FIG. 11 illustrates an exemplary operation wireless communication network 500 to control the radio capabilities in terrestrial 5GNR ANs 502 based on the usage of satellite ANs 504. The operation may differ in other examples. UEs 501 register with AMF 510 over 5GNR ANs 502. AMF 510 and SMF 513 interact to develop context (CXT) for an internet access service for UEs 501. The context indicates network addresses, service qualities, slice identifiers, and the like for UEs 501. SMF 513 transfers the context to UPF 516. AMF 510 transfers the context to 5GNR ANs 502. AMF 510 transfers the context to UEs 501 over 5GNR ANs 502. In response to the context, UEs 501 exchange internet data over 5GNR ANs 502 and UPF 516. UPF 516 transfers usage data for the internet access to SMF 513 which transfers the usage data to AMF 510. AMF 510 transfers the usage data to power control system 519. Power control system 519 processes the usage data to select RUs and DUs—including RU 701 and DU 702—to shut-down in 5GNR ANs 502, because the current load of these RUs and DUs can be adequately handled by SAT ANs 504, SAT GND 505, IWF 512, and slice 509. Power control system 519 transfers a Hand-Over (HO) instruction to AMF 510 for 5GNR ANs 502 to handover UEs 501 to SAT ANs 504. Over IWF 512 and SAT GND 505, AMF 510 directs SAT ANs 504 to serve internet access to UEs 501. Over 5GNR ANs 502, AMF 510 directs UEs 501 to use SAT ANs 504 for internet access.

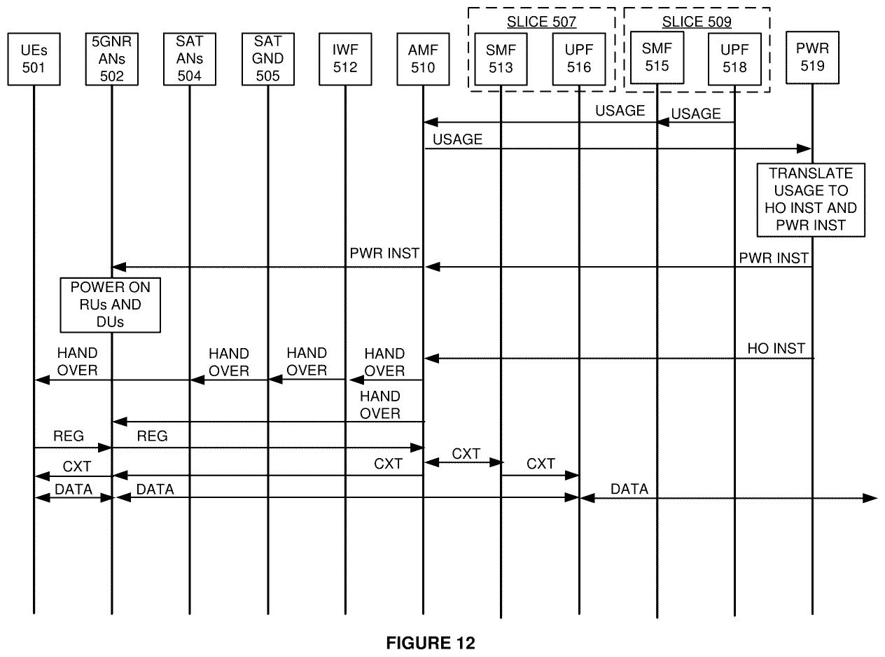

UEs 501 register with AMF 510 over SAT ANs 504, SAT GND 505, and IWF 512. AMF 510 and SMF 515 interact to develop context for an internet access service for UEs 501. The context indicates network addresses, service qualities, slice identifiers, and the like for UEs 501. SMF 515 transfers the context to UPF 518. AMF 510 transfers the context to IWF 512, SAT GND 505, and SAT ANs 504. AMF 510 transfers the context to UEs 501 over 5GNR ANs 502. In response to the context, UEs 501 exchange internet data over SAT ANs 504, SAT GND 505, IWF 512, and UPF 518. AMF 510 informs power control system 509 that the handover is complete. In response, power control system 519 signals CUs in 5GNR ANs 502 to power down select RUs and DUs—including signaling CU 703 to power down RU 701 and DU 702. The CUs power down the select RUs and DUs—including CU 703 powering down RU 701 and DU 702. The operation continues with a discussion of FIG. 12 below.

FIG. 12 illustrates an exemplary operation wireless communication network 500 to control the radio capabilities in terrestrial 5GNR ANs 502 based on the usage of satellite ANs 504. The operation may differ in other examples. The operation continues from the discussion of FIG. 11 above. UPF 518 transfers usage data for the internet access to SMF 515 which transfers the usage data to AMF 510. AMF 510 transfers the usage data to power control system 519. Power control system 519 processes the usage data to determine that some RUs and DUs in 5GNR ANs 502—including RU 701 and DU 702—should be repowered, because SAT ANs 504 can no longer handle an increasing internet-access load with sufficient quality. Power control system 519 transfers power instructions to 5GNR ANs 502 over AMF 510 to repower some of the RUs and DU—including RU 701 and DU 702. The CUs power up the RUs and DUs—including CU 703 powering up RU 701 and DU 702. Power control system 519 transfers a hand-over instruction to AMF 510 for SAT ANs 504 to handover UEs 501 to 5GNR ANs 502. AMF 510 directs 5GNR ANs 502 to serve internet access to UEs 501. Over IWF 512, SAT GND 505, and SAT ANs 504, AMF 510 directs UEs 501 to use 5GNR ANs 502 for internet access.

UEs 501 again register with AMF 510 over 5GNR ANs 502. AMF 510 and SMF 513 interact to develop context for the internet access service for UEs 501. The context indicates network addresses, service qualities, slice identifiers, and the like for UEs 501. SMF 513 transfers the context to UPF 516. AMF 510 transfers the context to 5GNR ANs 502 and to UEs 501 over 5GNR ANs 502. In response to the context, UEs 501 exchanges internet data over 5GNR ANs 502—including RU 701 and DU 702—and UPF 516.

Advantageously, wireless communication network 500 conserves the power consumed by 5GNR ANs 502. Moreover, wireless communication network 500 maintains adequate internet-access quality for UEs 501.

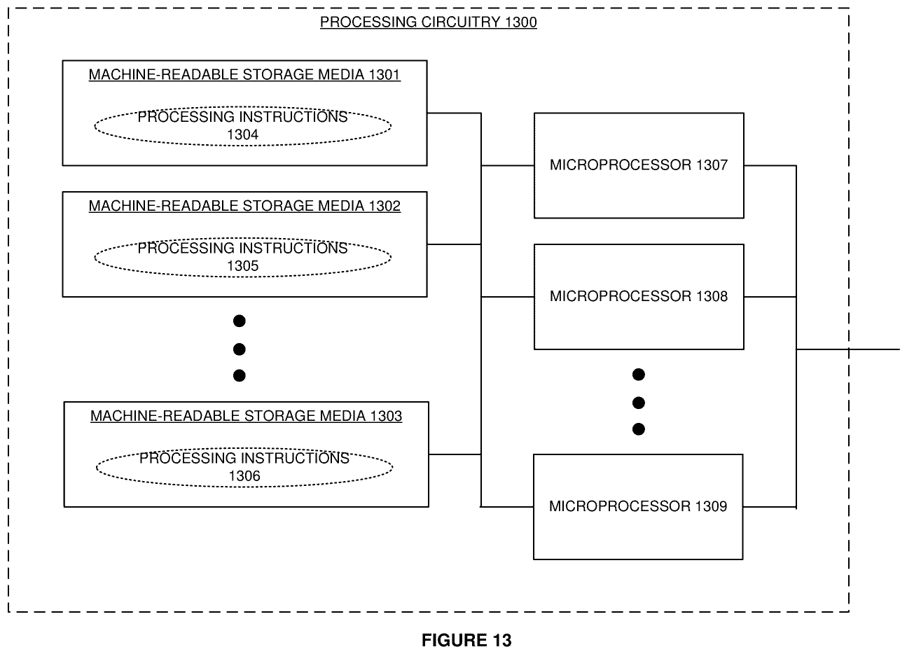

FIG. 13 illustrates exemplary processing circuitry 1300 to control power to a radio capability based on service quality. Processing circuitry 1300 comprises an example of user communication devices 101-103, systems 111-112, UEs 501, AN 400 and 502-504, GND 505, and NFVI 506, although devices 101-103, systems 111-112, UEs 501, ANs 400 and 502-504, GND 505, and/or NFVI 506 may differ. Processing circuitry 1300 comprises machine-readable storage media 1301-1303 and microprocessors 1307-1309 that are communicatively coupled. Machine-readable storage media 1301-1303 store processing instructions 1304-1306 in a non-transitory manner. Microprocessors 1307-1309 comprise DSPs, CPUs, GPUs, ASICs, and/or some other data processing hardware. Machine-readable storage media 1301-1303 comprises RAM, flash circuitry, disk drives, and/or some other type of data storage apparatus. Microprocessors 1307-1309 retrieve processing instructions 1304-1306 from non-transitory machine-readable storage media 1301-1303. Microprocessors 1307-1309 execute processing instructions 1304-1306 to control power to radio capabilities as described above for data system 100 and as described below for wireless communication network 500. The amount of storage media, microprocessors, processing instructions that are shown in FIG. 13 may vary in other examples.

The wireless communication system circuitry described above comprises computer hardware and software that form special-purpose data communication circuitry to control power to a radio capability based on service quality. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to control power to radio capabilities based on service quality.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
powering a radio capability to support a wireless data service;
estimating a future quality for the wireless data service if the radio capability is depowered;
depowering the radio capability based the estimate of the future quality;
determining an actual quality for the wireless data service when the radio capability is depowered; and
repowering the radio capability to support the wireless data service based on the determination of the actual quality.

2. The method of claim 1 wherein estimating the future quality comprises estimating the future quality based on radio configurations of user communication devices.

3. The method of claim 1 wherein estimating the future quality comprises estimating the future quality based on data flow types for the wireless data service.

4. The method of claim 1 wherein estimating the future quality comprises estimating the future quality based on a radio configuration of a wireless access node.

5. The method of claim 1 wherein estimating the future quality comprises estimating the future quality based on wireless usage of a wireless access node.

6. The method of claim 1 wherein estimating the future quality and determining the actual quality comprises estimating the future quality and determining the actual quality when satellite data communications are used to support the wireless data service.

7. The method of claim 1 wherein estimating the future quality and determining the actual quality comprises estimating the future quality and determining the actual quality when wireless fidelity data communications are used to support the wireless data service.

8. The method of claim 1 wherein:
estimating the future quality comprises estimating future data throughput amounts; and
determining the actual quality comprises determining actual data throughput amounts.

9. A method comprising:
a terrestrial access node using a radio capability to deliver a wireless data service;
a network control system determining initial usage of the wireless data service when delivered by the terrestrial access node, and based on the initial usage, transferring a depower signal for the radio capability to the terrestrial access node;
the terrestrial access node depowering the radio capability in response to the depower signal;
one or more satellite access nodes delivering the wireless data service when the radio capability is depowered;
the network control system determining subsequent usage of the wireless data service when delivered by the satellite access nodes, and based on the subsequent usage, transferring a repower signal for the radio capability to the terrestrial access node; and
the terrestrial access node repowering the radio capability in response to the repower signal and using the radio capability to deliver the wireless data service.

10. The method of claim 9 further comprising the network control system to direct user communication devices to use the one or more satellite access nodes based on the initial usage.

11. The method of claim 9 further comprising the network control system to direct user communication devices to use a wireless network slice based on the initial usage.

12. The method of claim 9 wherein the radio capability comprises a Multiple Input Multiple Output (MIMO) layer.

13. A data system comprising:
a data communication system to power a radio capability to support multiple wireless data services;
a communication control system to estimate future quality for the wireless data service if the radio capability is depowered, and based on the estimate, transfer a depower instruction for the radio capability to the data communication system;
the data communication system to depower the radio capability in response to the depower instruction;
the communication control system to determine an actual quality for the multiple wireless data services when the radio capability is depowered, and based on the determination, transfer a repower instruction for the radio capability to the data communication system; and
the data communication system to repower the radio capability to support the multiple wireless data services in response to the repower instruction.

14. The data system of claim 13 wherein the radio capability comprises a Multiple Input Multiple Output (MIMO) layer.

15. The data system of claim 13 wherein the radio capability comprises a radio frequency channel.

16. The data system of claim 13 wherein the radio capability comprises a Radio Unit (RU).

17. The data system of claim 13 wherein the radio capability comprises a Base-Band Unit (BBU).

18. The data system of claim 13 wherein the radio capability comprises a wireless network slice.

19. The data system of claim 13 wherein:
the communication control system is to transfer signaling to the data communication system to move one or more user communication devices off of a Multiple Input Multiple Output (MIMO) layer in response to the estimate of the future quality; and
the data communication system is to move the one or more of the user communication device off of the MIMO layer in response to the signaling and before depowering the radio capability.

20. The data system of claim 13 wherein:
the communication control system is to transfer signaling to the data communication system to move one or more user communication devices to a wireless network slice in response to the estimate of the future quality; and
the data communication system is to move the one or more of the user communication device to the wireless network slice in response to the signaling and before depowering the radio capability.
